(19) United States
(12) Patent Application Publication
(10) Pub. No.: US 2010/0246037 A1
(43) Pub. Date: Sep. 30, 2010

(54) VARIABLE SHAPE MIRROR SYSTEM

(75) Inventor: Masahiro NISHIO, Akiruno-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/728,653

(22) Filed: Mar. 22, 2010

(30) Foreign Application Priority Data
Mar. 26, 2009 (JP) 2009-076915

(51) Int. Cl. G02B 7/188

(52) U.S. Cl. 359/846

(57) ABSTRACT

A variable shape mirror system includes a deformation section on which a reflection surface and first electrode are formed, a fixing section on which a second electrode is formed, and which is configured to fix the deformation section, and a drive unit, at least one of the first electrode and second electrode is formed into divided electrodes constituted of a plurality of pairs of electrodes, and in the divided electrodes, a division boundary between the electrodes includes a circular shape. One drive voltage indicating signal is subjected to operation processing on the basis of a desired mirror shape for each of the divided electrodes, whereby a drive voltage is generated for each of the electrodes, the variable shape mirror is deformed into a desired shape, and an optimum aspheric component corresponding to the curvature of the reflection surface is realized.

### CROSS-REFERENCE TO RELATED APPLICATIONS

This application is based upon and claims the benefit of priority from prior Japanese Patent Application No. 2009-076915, filed Mar. 26, 2009, the entire contents of which are incorporated herein by reference.

### BACKGROUND OF THE INVENTION

1. Field of the Invention

The present invention relates to a variable shape mirror system constituted of a variable shape mirror in which a shape of a reflection surface is varied by electrostatic drive, and drive voltage control section configured to drive the variable shape mirror.

2. Description of the Related Art

In recent years, attention is paid to a variable shape mirror in which a shape of a reflection surface can be varied by using electrostatic drive through application of the MEMS technique, and the variable shape mirror is shown in, for example, Jpn. Pat. Appln. KOKAI Publication No. 2007-25503.

In FIG. 16, the configuration of a variable shape mirror of a conventional example is shown. In this configuration, voltages are applied to a plurality of electrode sections, and a variable shape mirror configured to correct wave-front distortion of reflection-surface light flux by deforming the reflection surface of a deformation mirror section constituted of a thin-film-like reflection surface arranged in opposition to the electrodes, and configured to generate distortion by the electrostatic voltages applied to the electrode sections is constituted.

The configuration is proposed in which light from an object reflected by this variable shape mirror is detected, application voltages to the electrode sections corresponding to a reflection surface shape set as a point of reference are regarded as a set, and a predetermined number of sets corresponding to predetermined different numbers of reflection surface shapes is stored, a set of application voltages suitable for a targeted detection signal is selected, the predetermined set of application voltages corresponding to the reflection surface shape is updated, and a variable shape mirror is deformed on the basis of the updated set.

### BRIEF SUMMARY OF THE INVENTION

An embodiment according to the present invention is intended to change a reflection surface to have a desirable shape by application of a plurality of driving electrodes based on simple structure and control, and provides a variable shape mirror system comprising a deformation section on which a reflection surface and first electrode is formed, a fixing section on which a second electrode is formed, and which is configured to fix the deformation section, and a drive unit configured to apply a potential difference to a part between the first and second electrodes in order to deform the deformation section, wherein at least one of the first electrode and second electrode is formed into divided electrodes constituted of a plurality of pairs of electrodes, and in the divided electrodes, a division boundary between the electrodes comprises a circular shape, and is a circle concentric with an axis passing through a central point of the deformation section, and intersecting the reflection surface at right angles to the surface.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a variable shape mirror system in a first embodiment.

FIG. 2 is a top view showing a top external appearance of the variable shape mirror viewed from above.

FIG. 3A is a cross-sectional view showing the cross section configuration at a position A-A′ in FIG. 2.

FIG. 3B is a view showing a configuration example in which the electrode on the mirror substrate side is made the divided electrodes.

FIG. 3C is a view showing a configuration example in which both the electrode on the electrode substrate side, and electrode on the mirror substrate side are made the divided electrodes.

FIG. 4A is an exploded view showing the internal configuration of the variable shape mirror by removing the mirror substrate to expose the inside.

FIG. 4B is an exploded view showing the mirror substrate.

FIG. 5 is a view showing the coordinates for shape expression and parameters.

FIG. 6 is a view showing an example of an aspheric component of the reflection surface changing according to the deformation amount.

FIG. 7 is a view showing a relationship between the deformation amount d0 of the reflection surface center and aspheric component d2.

FIG. 8 is a view showing the electrode arrangement and an aspheric component of a reflection surface.

FIG. 9 is a graph showing a relationship between voltages applied to first to third divided electrodes and deformation amounts.

FIG. 10 is a graph showing a relationship between the drive voltage V1 and variation in increase/decrease amount of drive voltages V2 and V3 for the drive voltage V1.

FIG. 11 is a graph showing an example of a drive voltage graph of an operation result.

FIG. 12 is a graph showing an example of a drive voltage graph in which the drive voltage V2 is rounded off to 0V.

FIG. 13 is a block diagram showing the configuration of a variable shape mirror system according to a modification example of the first embodiment.

FIG. 14 is a block diagram showing the configuration of a variable shape mirror system in a second embodiment.

FIG. 15 is a block diagram showing the configuration of a variable shape mirror system in a modification example of the second embodiment.

FIG. 16 is a block diagram showing the configuration of a variable shape mirror system based on the prior art technique.

### DETAILED DESCRIPTION OF THE INVENTION

Embodiments of the present invention will be described below in detail with reference to the drawings.

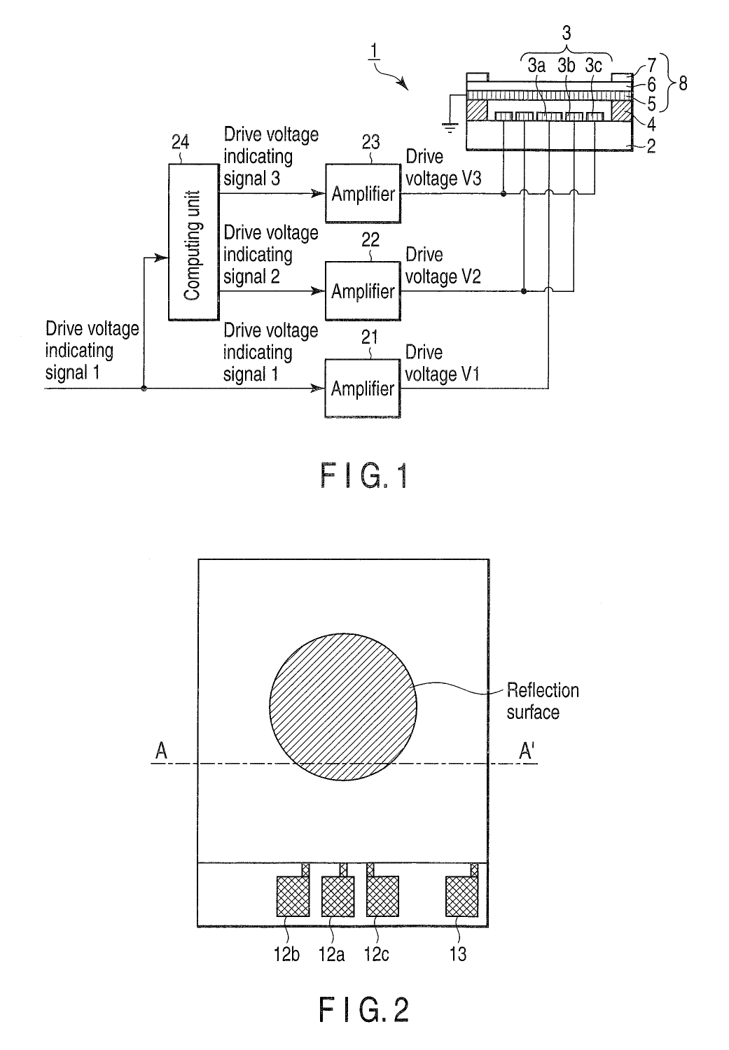

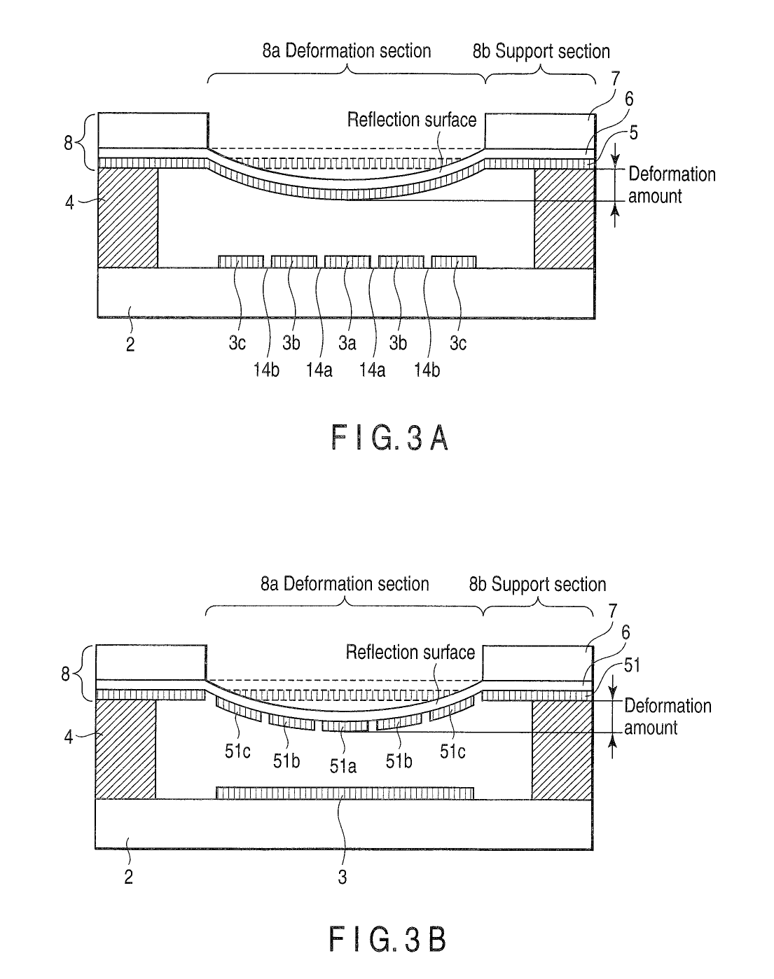

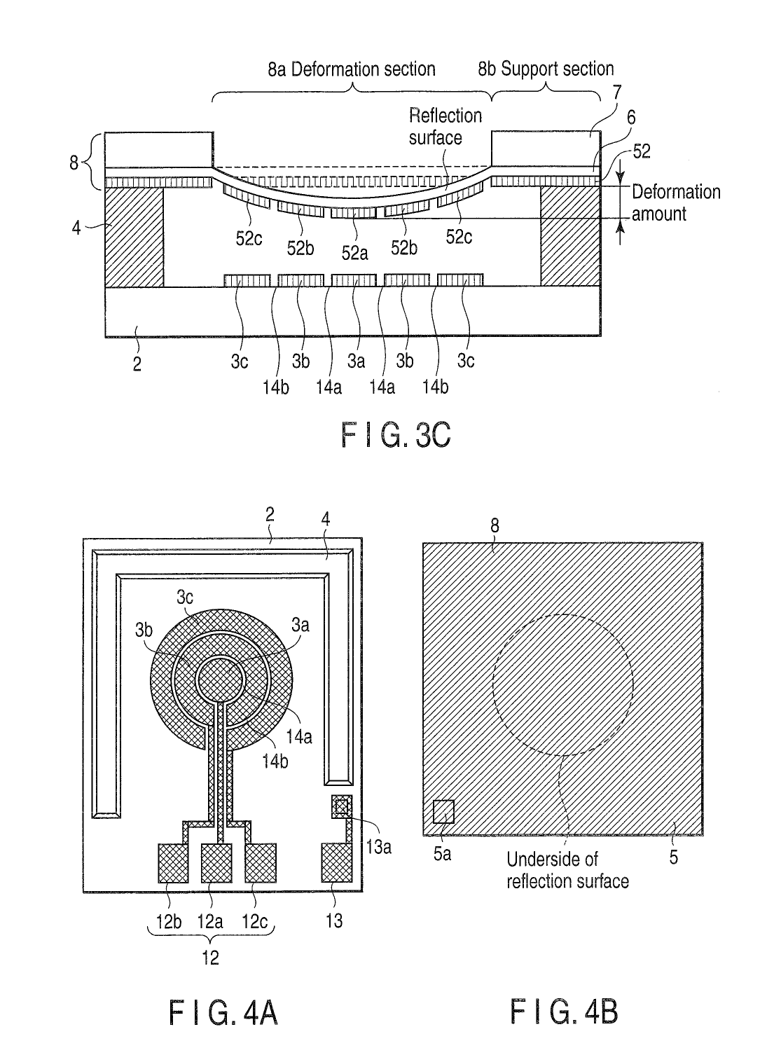

A variable shape mirror system according to a first embodiment will be described below with reference to FIG. 1, FIG. 2, FIG. 3, and FIG. 4. FIG. 1 is a block diagram showing the configuration of the variable shape mirror system in this embodiment. FIG. 2 is a top view showing a top external appearance of the variable shape mirror viewed from above. FIG. 3A is a cross-sectional view showing the cross section configuration at a position A-A′ in FIG. 2, and FIG. 4A and FIG. 4B are exploded views showing the internal configuration of the variable shape mirror by removing the mirror substrate to expose the inside.

### (Explanation of Device Structure)

As shown in FIG. 3, the variable shape mirror 1 of this embodiment is configured in such a manner that an electrode substrate 2 and mirror substrate 8 are fixed by a spacer in opposition to each other.

As shown in FIG. 4A, on the electrode substrate 2, the divided electrodes 3a, 3b, and 3c are each constituted of a circular first divided electrode 3a arranged in the center, annular (or doughnut-like) second divided electrode 3b arranged concentric with the first divided electrode 3a on the periphery of the electrode 3a, and electrically separate from the electrode 3a, and annular third divided electrode 3c arranged on the periphery of the electrode 3b electrically separate from the electrode 3b. That is, the above configuration is the configuration in which one circular electrode is electrically separated into three parts by two annular separation spaces 14a and 14b concentric with each other. The center of these electrodes is arranged in such a manner that the center coincides with the center of a deformation section 8a (FIG. 3) of the mirror substrate 8 to be described later.

Needless to say, the number of divided electrodes is not limited to 3, and the electrode may be divided into an appropriate number of parts on the basis of design. Further, in this embodiment, among the electrodes arranged on the electrode substrate 2 and mirror substrate 8 opposed to each other, the common electrode 5 to be described later may be made the divided electrodes 51a, 51b, and 51c as shown in FIG. 3B, further both the electrode on the electrode substrate 2 and common electrode 5 may be made divided electrodes, i.e., divided electrodes 3a, 3b, and 3c, and divided electrodes 52a, 52b, and 52c as shown in FIG. 3C. In the example to be described below, the electrode 3 provided on the electrode substrate 2 side is made the divided electrodes.

The first divided electrode 3a, second divided electrode 3b, and third divided electrode 3c are electrically connected to a first lead electrode 12a, second lead electrode 12b, and third lead electrode 12c provided on the end part side of the electrode substrate 2 by wiring.

As shown in FIG. 3A, the mirror substrate 8 is constituted of a deformation section 8a, and support section 8b, and a support member 7 constituting the support section 8b supports the deformation section 8a from the outer circumference side, and is used as a fixing section when the deformation section 8a is fixed to the electrode substrate 2 through the spacer 4. The first lead electrode 12a, second lead electrode 12b, and third lead electrode 12c on the electrode substrate 2 are fixed in opposition to the deformation section 8a formed on the mirror substrate 8.

As shown in FIG. 4B, on the whole surface side of the mirror substrate 8 opposed to the electrode substrate 2, a film of a conductive material such as a metal or the like is formed, and is used as a common electrode 5. The surface on which the common electrode 5 is formed is made the underside, while on the surface of the mirror substrate, a reflection surface 6 constituted of a film of a metal or the like is formed on the deformation section 8a. Although the material to be formed into the film differs depending on the specification of the reflection characteristic of the variable shape mirror, aluminum, gold or a dielectric multilayer film can be used. When a metal such as aluminum having an oxidation nature in the atmosphere is used, an oxide film such as a silicon oxide film or nitride film is further formed to coat the metal surface therewith. It should be noted that when a coating film is formed, the film thickness is considered so that the reflectance is not lowered.

The spacer 4 is used to fix the mirror substrate 8 while determining the gap between the electrode substrate 2 and mirror substrate 8. As the substrate material, an inorganic material, metal, and the like such as glass, and a silicon substrate can be used. Further, as another method, an organic adhesive containing beads having a diameter determining the gap may be used.

In order to electrically connect the common electrode 5 of the mirror substrate 8 to a common lead electrode 13 formed on the electrode substrate 2, part of the common electrode 5 provided on the support member 7 of the mirror substrate 8 is made a connection section 5a and, when the mirror substrate 8 is fixed, the connection section 5a thereof and a connection electrode 13a formed on the electrode substrate 2 are electrically connected to each other by means of a conducting material (not shown) for electric connection. The section 5a and electrode 13a may be connected to each other by pressure welding by a metallic member, or may be connected by using a conductive paste or the like. The common lead electrode 13 and connection electrode 13a are connected to each other on the electrode substrate 2. As a result of this, the common electrode 5 on the mirror substrate 8, and common lead electrode 13 on the electrode substrate 2 are electrically connected to each other. Although the electrical connection between each of the common lead electrode 13, first lead electrode 12a, second lead electrode 12b, and third lead electrode 12c and outside of the variable shape mirror is not shown, the connection is normally carried out by wire bonding.

The overall configuration of the variable shape mirror system shown in FIG. 1 will be described below.

The variable shape mirror system of this embodiment is constituted of the variable shape mirror 1 described previously, amplifier 21 configured to receive a drive voltage indicating signal 1 to be described later, and apply an amplified drive voltage V1 to the first divided electrode 3a, amplifier 22 configured to receive a drive voltage indicating signal 2 to be described later, and apply an amplified drive voltage V2 to the second divided electrode 3b, amplifier 23 configured to receive a drive voltage indicating signal 3 to be described later, and apply an amplified drive voltage V3 to the third divided electrode 3c, and computing unit 24 configured to receive the drive voltage indicating signal 1, and apply the drive voltage indicating signals 2 and 3 to the amplifiers 22 and 23, respectively. The drive voltage indicating signal 1 input to this system is output from a control section (not shown), and is input to the amplifier 21 and computing unit 24. In the computing unit 24, an operation to be described later is carried out, drive voltage indicating signal 2 and drive voltage indicating signal 3 are generated, and are output to the second divided electrode 3b, and third divided electrode 3c.

### (Explanation of Drive Principle)

In the variable shape mirror 1 of this embodiment, the electrostatic drive system in which a reflection surface on the deformation section 8a is deformed by electrostatic force is employed. As shown in FIG. 1, the common electrode 5 is connected to the zero potential (GND), the same or different drive voltages are applied to the first divided electrode 3a, second divided electrode 3b, and third divided electrode 3c by the amplifiers 21, 22, and 23, respectively, whereby potential difference are generated between the plurality of pairs of electrodes, that is, potential difference be generated by each between common electrode 5 and 1st divided electrode 3a, between common electrode 5 and 2nd divided electrode 3b, and between common electrode 5 and 3rd divided electrode 3c, and the reflection surface is deformed while facing toward the electrode substrate 2 together with the deformation section 8a by the generated electrostatic attractive force.

At this time, when the same drive voltage is applied to each electrode of the first divided electrode 3a, second divided electrode 3b, and third divided electrode 3c, the reflection surface becomes substantially spherical. The deformation shape of the reflection surface can be formed into a desired shape by changing the values of drive voltages to be applied to the first divided electrode 3a, second divided electrode 3b, and third divided electrode 3c. The maximum value of the deformation amount of the central part of the reflection surface is limited by, for example, the gap between the electrode substrate 2 and mirror substrate 8 determined by the height of the spacer 4, and it is generally said that the maximum value is limited to one-third or less of the gap between the substrates.

Next, the targeted deformation shape in the variable shape mirror 1 will be described below.

The variable shape mirror system of this embodiment is incorporated in an optical instrument known to the public, and realizes a necessary reflection surface shape required by the optical design of the optical instrument. The necessary reflection surface shape is an axisymmetric shape having the central axis of the reflection surface as the axis thereof, and is realized by changing the curvature of the reflection surface in accordance with an instruction of the optical instrument, and adjusting the aspheric component of the reflection surface shape in accordance with the curvature.

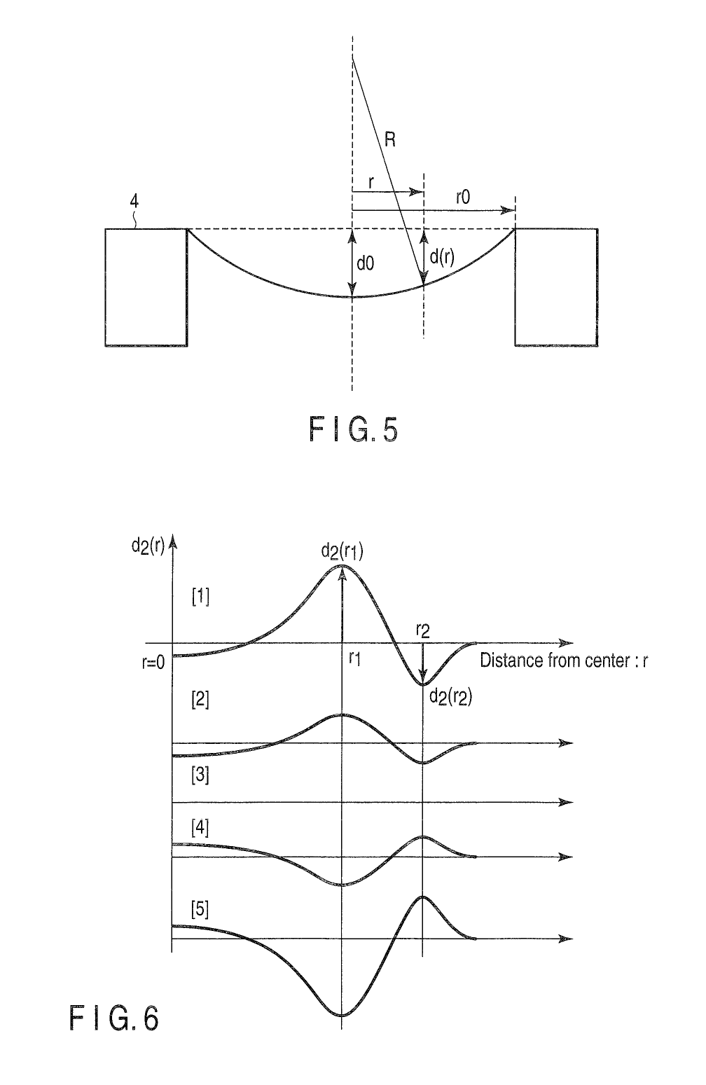

FIG. 5 is a view showing the coordinates for shape expression and parameters. As shown in FIG. 5, assuming that the center of the reflection surface is the origin, a distance from the origin is r, and a deformation amount at the position of the distance r is d (r), the axisymmetric shape of the reflection surface can be expressed by the following formula (1).

d(r)=d₀+R−\sqrt{R²−r²}+A·r⁴+B·r⁶+C·r⁸ formula (1)

Here, R is the radius of curvature, r₀ is the radius of the deformation section, d₀ is the deformation amount of the reflection surface center, r is the position (distance from the center) at which the deformation amount of the reflection surface is to be derived, d (r) is the deformation amount of the reflection surface at the position r, and A, B, and C are coefficients of the aspheric components to be described later. Further, assuming that the spherical component is d1 (r), and aspheric component (remaining component after subtracting the spherical component from the reflection surface shape) is d2 (r), the shape of the reflection surface is constituted of the sum of the spherical component and aspheric component as shown by the following formulas.

d(r)=d₁(r)+d₂(r)

d₁(r)=d₀+R−\sqrt{R²−r²} formula (2) [spherical component]

d₂(r)=A·r⁴+B·r⁶+C·r⁸ formula (3) [aspheric component]

Here, the curvature of the reflection surface corresponds to R of formula (2) [spherical component], and is determined by the deformation amount d₀ of the reflection surface center, and reflection surface radius r0 through the following formula (4).

$$R = \frac{{d}_{0}^{2} + {r}_{0}^{2}}{2 {d}_{0}} \qquad formula ( 4 )$$

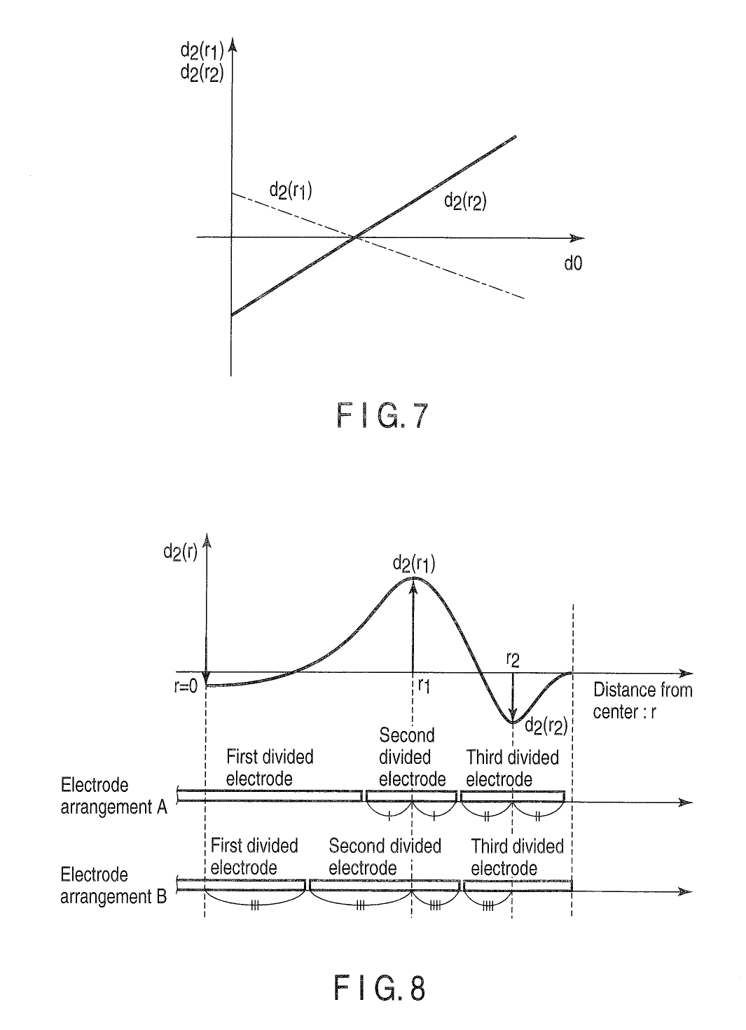

Accordingly, as described previously, obtaining the aspheric component of the reflection surface in accordance with the curvature can be realized by adjusting the aspheric component in accordance with the deformation amount d₀. An example of the aspheric component changing in accordance with d₀ is shown in FIG. 6. With the change of d₀, the aspheric component changes as shown in [1] to [5] in FIG. 6. The positions at which the aspheric component exhibits extreme values become fixed positions independently of d₀. Here, assuming that radii r of positions at which extreme values are exhibited are r1 and r2, and the amounts of aspheric components at the positions are d2 (r1) and d2 (r2), the relationships between d₀ and d2 (r1) and d2 (r2) are the relationships shown in FIG. 7. At d₀ at which d2 (r1) and d2 (r2) intersect each other, both d2 (r1) and d2 (r2) are 0, and hence the aspheric component becomes 0, and the necessary reflection surface shape is a spherical surface.

### (Position of Electrode Division)

FIG. 8 is a view showing the electrode arrangement and aspheric component. As described previously, the first divided electrode 3a, second divided electrode 3b, and third divided electrode 3c have a circular shape, and doughnut-like shapes provided on the periphery of the circular shape which are concentric with each other. When attention is paid to the radial direction of each of the divided electrodes 3a, 3b, and 3c, the electrodes are arranged in such a manner that the positions (r=r1) and (r=r2) at which the aspheric component of the reflection surface exhibits extreme values, and central positions of the doughnut-like shapes of the second divided electrode 3b, and third divided electrode 3c in the radial direction coincide with each other (electrode arrangement A shown in FIG. 8).

Regarding the first divided electrode 3a, the center of the circular shape of the electrode coincides with the center of the reflection surface. The aspheric component has an extreme value in the center of the reflection surface too, and hence regarding the first divided electrode too, it can be said that the center of the electrode and position at which the aspheric component exhibits an extreme value coincide with each other.

Further, paying attention to the boundaries between the electrodes, it is also possible to arrange the electrodes in such a manner that the boundary between the first electrode and second electrode is present at a midpoint between the reflection surface center and r1, and boundary between the second electrode and third electrode is present at a midpoint between r1 and r2. (electrode arrangement B shown in FIG. 8).

### (Explanation of Method of Determination of Drive Voltage)

Next, the operation processing in the computing unit 24 will be described below.

The drive voltage indicating signal 1 to be input to the system of this embodiment is input to the amplifier 1, and is further input to the computing unit 24. In the computing unit 24, the operation to be described later is carried out, and the drive voltage indicating signal 2, and drive voltage indicating signal 3 are output from the unit 24.

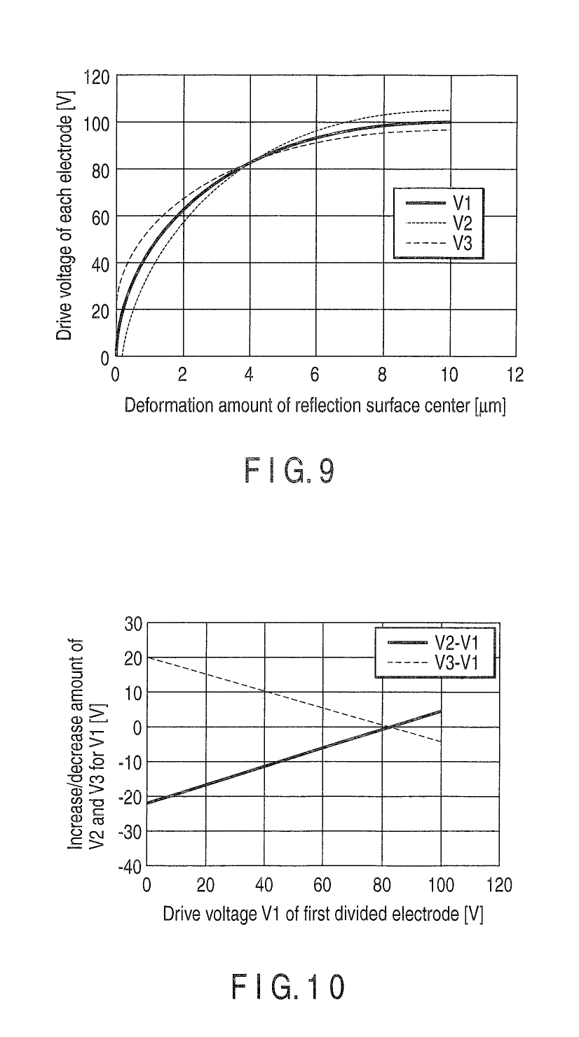

Voltages to be applied to the first divided electrode 3a, second divided electrode 3b, and third divided electrode 3c are set as the drive voltage V1, drive voltage V2, and drive voltage V3. Here, when V1=V2=V3 is set, the shape of the reflection surface becomes the spherical shape. Further, it is possible to increase/decrease d2 (r1) and d2 (r2) by increasing/decreasing V2 and V3 with respect to V1. Drive voltages V1, V2, and V3 by which the necessary aspheric component shown in FIG. 6 can be obtained are shown in FIG. 9. The drive voltages corresponding to the deformation amounts can be obtained in advance by the method to be described later.

As shown in FIG. 10, when a change in increase/decrease amount of the drive voltages V2 and V3 for the drive voltage V1 is obtained on the basis of the value obtained by the method to be described later, the result is as follows. The increase/decrease amount of the drive voltage V2 and drive voltage V3, i.e., (V2-V1) and (V3-V1) have substantially linear relationships to the drive voltage V1. Here, the linear relationships can be expressed by the following formulas.

V₂−V₁=α₁×V₁+β₁

V₃−V₁=α₂×V₁+β₂ formulas (5)

Then, the formulas (5) can be rewritten as the following formulas (6).

V₂=(α₁+1)×V₁+β₁=α₁′×V₁+β₁

V₃=(α₂+1)×V₁+β₂=α₂′×V₁+β₂ formulas (6)

By using the above relationships, and by obtaining the voltages of the second divided electrode 3b, and third divided electrode 3c on the basis of the voltage of the first divided electrode 3a in accordance with the linear relationship, it is possible to obtain the necessary reflection surface shape. Values output from the computing unit 24 are the drive voltage indicating signals 1, 2, and 3 to be input to the amplifiers 21, 22, and 23, and hence it is sufficient if the values of these signals are obtained from the drive voltages V1, V2, and V3 in consideration of the amplification factors of the amplifiers 21, 22, and 23.

It should be noted that in this embodiment, although the configuration in which the computing unit is constituted of a linear computing unit, and the voltages of the divided electrodes are obtained by linear operation has been described, it is also possible to employ the configuration in which a memory storing therein a table of relationships between the voltage value of the first divided electrode 3a, and the voltage values of the second divided electrode 3b and third divided electrode 3c is provided, and conversion is carried out by using the table. At this time, it is also possible to use a method in which as the memory, a nonvolatile memory is used, and data is written thereto at the time of shipment of the system from the factory.

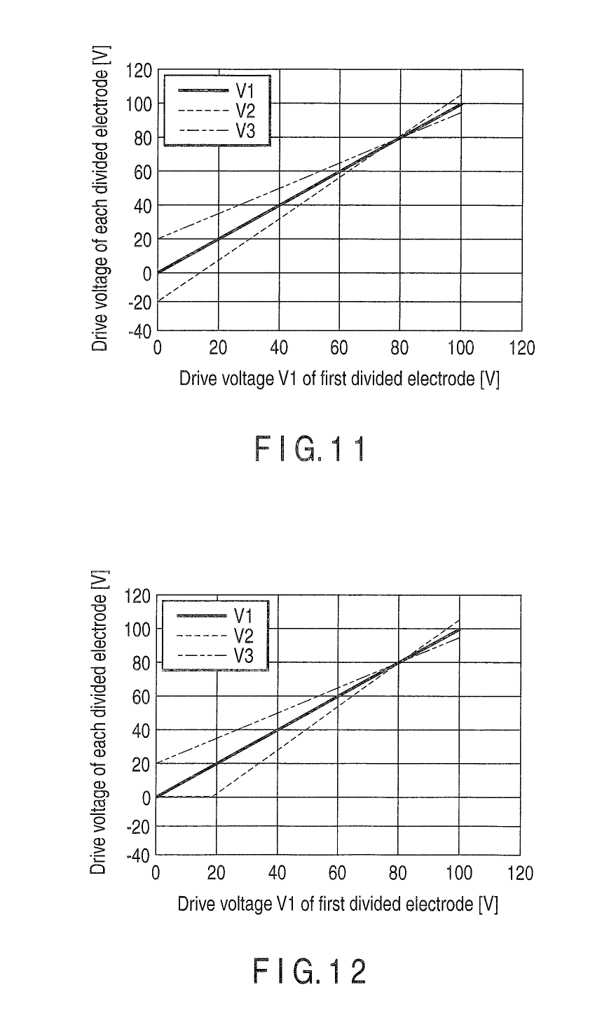

A graph of the drive voltages obtained as a result of the operation described above is shown in FIG. 11. In the area in which the drive voltage V1 is 20 V or less, the drive voltage V2 exhibits negative values, this indicating that generation of repulsive force is necessary. However, even when a negative voltage is actually applied, the same attraction force as the positive voltage is generated in the electrostatic force drive, and a shape far apart from the necessary reflection surface shape is produced. Thus, when a result of the operation becomes lower than 0 V, it is possible to bring the shape closer to the necessary reflection surface shape than the case where the negative voltage is applied by rounding off the operation result to 0 V.

### (Parameter Derivation Method)

A parameter derivation method in the above-mentioned linear relationship will be described below.

First, a set of drive voltages of the divided electrodes required to realize the necessary shape is obtained. In order to obtain the drive voltages, a difference shape between the necessary shape and the shape of the deformation section is calculated, and the drive voltages are optimized so that the difference shape can be made small. As the method of the optimization, the hill-climbing method may be used, and simulated annealing method, genetic algorithm, and the like may also be used. The necessary shape differs depending on the deformation amount of the center of the reflection surface, and hence sets of the drive voltages by which the necessary shapes for a plurality of deformation amounts can be acquired are obtained.

Next, a linear relationship is obtained on the basis of the obtained sets of the drive voltages for the plurality of deformation amounts.

The drive voltages V1, V2, and V3 for the first deformation amount are set as the voltages V11, V21, and V31, and drive voltages V1, V2, and V3 for the second deformation amount are set as the voltages V12, V22, and V32. Then, from the formulas (6), the following formulas are set. The above voltage values satisfy the following formulas.

$$\{ \begin{matrix}{V}_{21} = {α}_{1}^{′} \times {V}_{11} + {β}_{1} \\ {V}_{22} = {α}_{1}^{′} \times {V}_{12} + {β}_{1}\end{matrix} \\ \{ \begin{matrix}{V}_{31} = {α}_{2}^{′} \times {V}_{11} + {β}_{2} \\ {V}_{32} = {α}_{2}^{′} \times {V}_{12} + {β}_{2}\end{matrix}$$

By solving the above simultaneous equations, the following items can be obtained.

α₁′, β₁, α₂′, β₂

By the procedure described above, it is possible to obtain the parameters expressing the linear relationship used in the computing unit. It should be noted that the computing unit may be provided with a memory configured to store the parameters described above. At this time, it is also possible to employ a method in which as the memory, a nonvolatile memory is used, and data is written thereto at the time of shipment of the system from the factory.

Further, although the number of electrode division has been set to three, the number of division may be two or more than three. At this time, it is advisable to determine the number of division in accordance with the number of inflection points of the aspheric shape. The configuration in which the number of inflection points+1 is set as the number of division is conceivable as one configuration. Further, in this embodiment, although electrode division is carried out only on the fixing section side, the configuration in which electrode division is carried out only on the deformation section side, or on both the deformation section side and fixing section side may be employed.

As described above, according to this embodiment, one drive voltage indicating signal is subjected to operation processing based on the desired reflection surface shape for each of the divided electrodes, whereby it is possible to generate the drive voltage of each of the electrodes, and deform the variable shape mirror into a desired shape. The drive voltages of the electrodes obtained by the computing unit become the voltages configured to realize the optimum aspheric component in accordance with the curvature of the reflection surface, and hence it is possible to obtain the optimum aspheric component in accordance with the specified deformation amount.

Accordingly, it is not necessary to prepare in advance a large number of templates corresponding to the shape unlike in the conventional variable shape mirror and, further it is not necessary to update the template during the control. This embodiment makes it possible to manufacture a variable shape mirror of a desired shape by simple control.

Next, a modification example of the first embodiment will be described below.

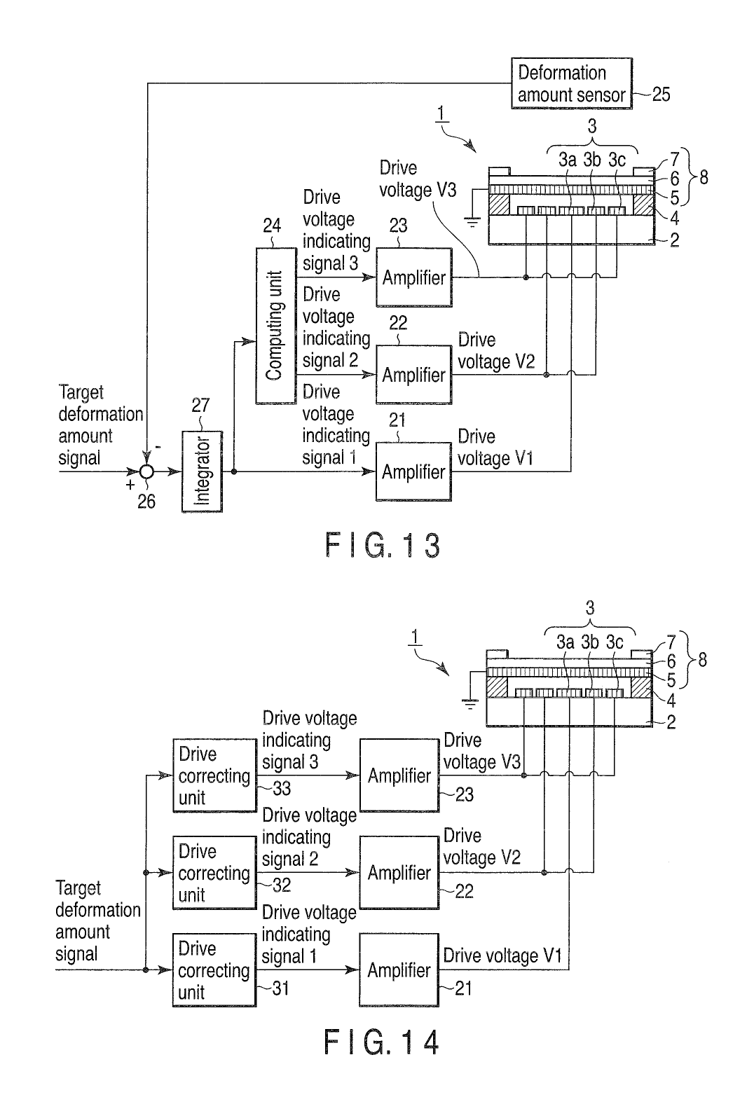

This modification example is configured in such a manner that as shown in FIG. 13, a deformation amount sensor 25 configured to detect a deformation amount d0 of the reflection surface center is arranged above a deformation section 8a, the detected deformation amount d0 is fed back to a subtracter 26, an integration result of an integrator 27 is input to an amplifier 21 and computing unit 24, and computation results of the computing unit 24 are input to amplifiers 22 and 23 as drive voltage indicating signals 2 and 3. Among the constituent parts of this modification example, parts identical with the constituent parts of the first embodiment described previously are denoted by the identical reference symbols, and a description of them is omitted. As the deformation amount sensor, a sensor configured to detect the deformation amount by using a distortion amount of the reflection surface, sensor configured to optically detect the deformation amount of the reflection surface, sensor configured to detect the deformation amount by using electrostatic capacity between electrodes, and the like may be used. Although the deformation amount sensor is arranged above a deformation section, the arrangement position of the sensor may be changed to an optimum position according to the type of the sensor.

This modification example is configured in such a manner that the deformation sensor 25 is used to control the reflection surface shape while keeping the curvature (deformation amount) constant. The deformation amount d0 of the reflection surface center is measured by means of the deformation sensor 25, and a drive voltage indicating value 1 is obtained by the feedback of the measured deformation amount d0.

According to this modification example, even when the rigidity or the like of the deformation section 8a has changed due to a change in environment, it is possible to keep the curvature of the reflection surface at a specified constant value by means of the deformation amount sensor 25. Further, the voltages of the electrodes obtained by the computing unit become the voltages realizing the optimum aspheric component according to the curvature of the reflection surface, and hence it is possible to obtain the optimum aspheric component according to the specified deformation amount.

Next, a variable shape mirror system according to a second embodiment will be described below with reference to FIG. 14.

This embodiment is configured in such a manner that drive voltage indicating signals 1, 2, and 3 to be input to amplifiers 21, 22, and 23 are generated by drive correcting units 31, 32, and 33. Among the constituent parts of this embodiment, parts identical with the constituent parts of the first embodiment described previously are denoted by the identical reference symbols, and a description of them is omitted.

In this embodiment, a target deformation amount signal input to the system is input to the drive correcting units 31, 32, and 33. These drive correcting units 31, 32, and 33 carry out signal processing to be described later, and output drive voltage indicating signals 1, 2, and 3 to the amplifiers 21, 22, and 23. Each of the amplifier 21, amplifier 22, and amplifier 23 is connected to corresponding one of a first divided electrode 3a, second divided electrode 3b, and third divided electrode 3c, amplifies a value of corresponding one of the drive voltage indicating signals 1, 2, and 3 input to the amplifiers, and applies the drive voltage to the electrode. As the function to be used in the drive correcting unit, the function expressed by the following formula can be used.

V=k(dᵢₙᵢₜ−Δd)\sqrt{Δd}+V_{off}

(Δd: target deformation amount signal, V: drive voltage)

At this time, as dinit which is the parameter of each of the drive correcting units, a common value is used, and as k and Voff, values suitable for each electrode are used, whereby it is possible to obtain drive voltages 1 to 3 as shown in FIG. 11. Accordingly, in this embodiment, it is possible to obtain a deformation amount corresponding to the input target deformation amount signal, and an aspheric component corresponding to the deformation amount, in addition to the advantage of the first embodiment described previously.

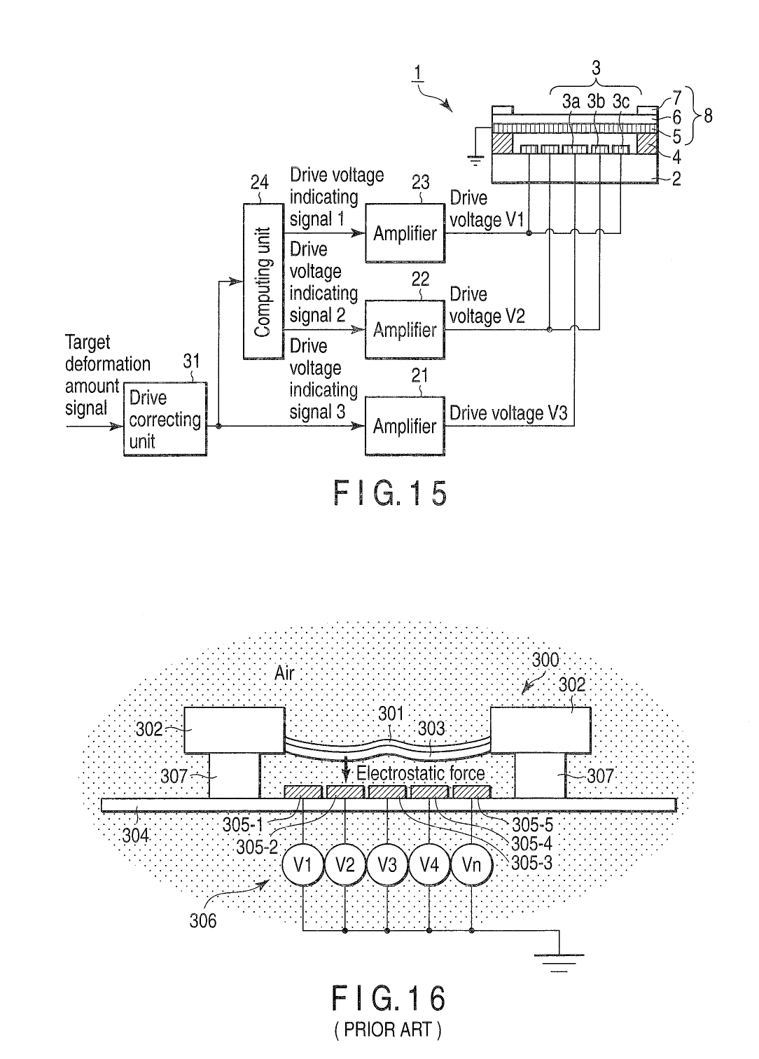

Next, a variable shape mirror system according to a modification example of the second embodiment will be described below with reference to FIG. 15.

This embodiment shown in FIG. 15 is configured in such a manner that a drive correcting unit 31 and computing unit 24 are provided in place of the drive correcting units 31, 32, and 33 in FIG. 14. Parts identical with the constituent parts of the first embodiment, and second embodiment described previously are denoted by the identical reference symbols, and a description of them is omitted.

In this configuration, the target deformation signal is subjected to the above-mentioned signal processing by the drive correcting unit 31, and is then input to the amplifier 21 and computing 24 as a drive voltage indicating signal 1. The amplifier 21 amplifies the drive voltage indicating signal 1 on the basis of a predetermined amplification factor, and generates a drive voltage V1. Further, at the same time, computation results of the computing unit 24 based on the drive voltage indicating signal 1 are input to the amplifiers 22 and 23 as drive voltage indicating signals 2 and 3, whereby drive voltages V2 and V3 are generated. These drive voltages V1, V2, and V3 are applied to divided electrodes 3a, 3b, and 3c.

In this embodiment too, the target deformation signal is converted into the drive voltage indicating signal by using the drive correcting unit, whereby the function/advantage identical with the first embodiment described previously can be obtained. Further, this embodiment can be realized by a simpler configuration than the second embodiment.

Although the present invention has been described above on the basis of the embodiments, the present invention is not limited to the embodiments described above, and it goes without saying that the invention can be variously modified or applied within the scope of the gist of the invention.

### (Supplementary Note)

From the specific embodiments described previously, inventions configured in the following manner can be extracted. It should be noted that items in the following brackets are the reference symbols of the constituent parts described in the drawings.

[1] A variable shape mirror system characterized by comprising:

a deformation section (8) on which a reflection surface (6) and first electrode (5) are formed;

a fixing section (2) on which a second electrode (3) is formed, and which is configured to fix the deformation section (8); and

a drive unit (21, 22, 23) configured to apply a potential difference to a part between the first and second electrodes in order to deform the deformation section, wherein

at least one of the first electrode (5) and second electrode (3) is formed into divided electrodes, the divided electrodes are constituted of a plurality of pairs of electrodes (a plurality of electrodes 3a, 3b, 3c), and

a division boundary between the electrodes comprises a circular shape, and is a circle concentric with an axis passing through a central point of the deformation section (8a), and intersecting the reflection surface (6) at right angles to the surface.

The variable shape mirror system according to [1] is based on the first embodiment, and FIG. 1, FIG. 3, and FIG. 4.

### (Function/Advantage)

In the variable shape mirror system of this embodiment, the three divided electrodes 3a, 3b, and 3c provided on the electrode substrate 2 are formed into concentric circular shapes around the central axis of the reflection surface, and it is possible to adjust the aspheric component of the reflection surface as shown in FIG. 6 by individually applying a drive voltage to each of the divided electrodes.

[2] The variable shape mirror system according to item [1], characterized in that

the second electrode (3) is constituted of divided electrodes, and first electrode (5) is arranged in opposition to the second electrode (3).

The variable shape mirror system according to [2] is based on the first embodiment and FIG. 3A.

### (Function/Advantage)

The variable shape mirror system according to [2] is associated with a configuration example in which the divided electrodes 3a, 3b, and 3c are provided on the electrode substrate 2 of the first embodiment, and common electrode 5 is provided on the mirror substrate 8.

[3] The variable shape mirror system according to item [1], characterized in that

the first electrode (5) is constituted of divided electrodes, and second electrode is arranged in opposition to the first electrode.

The variable shape mirror system according to [3] is based on the first embodiment and FIG. 3B.

### (Function/Advantage)

The variable shape mirror system according to [3] is associated with a configuration in which the arrangement is made by interchanging the divided electrodes and common electrode of the first embodiment, i.e., the common electrode is provided on the electrode substrate 2 side, and divided electrodes are provided on the mirror substrate 8 side. Thus, the function/advantage identical with the first embodiment can be obtained.

[4] The variable shape mirror system according to claim 1, characterized in that both the first electrode and second electrode are constituted of divided electrodes, and these electrodes are arranged in opposition to each other.

The variable shape mirror system according to [4] is based on the first embodiment and FIG. 3C.

### (Function/Advantage)

The variable shape mirror system according to [4] is associated with a configuration in which both the divided electrodes and common electrode of the first embodiment are provided as divided electrodes. It is possible to more finely adjust the aspheric component of the reflection surface than in the first embodiment.

[5] The variable shape mirror system according to claims 1 to 4, characterized in that the electrode is divided in such a manner that a central position of a width of each electrode of the plurality of pairs of electrodes in the radial direction coincides with a position at which an aspheric component of the shape of the reflection surface comprises an extreme value.

The variable shape mirror system according to [5] is based on the first embodiment and FIG. 8 (electrode arrangement A).

### (Function/Advantage)

The width center of the electrode and the position at which the aspheric component of the reflection surface shape comprises an extreme value coincide with each other, whereby it is possible to smoothly adjust the aspheric component.

[6] The variable shape mirror system according to claims 1 to 4, characterized in that

the electrode is divided in such a manner that a division boundary between each electrode of the plurality of pairs of electrodes coincides with a midpoint position between positions of extreme values of the aspheric component of the reflection surface shape adjacent to each other.

The variable shape mirror system according to [6] is based on the first embodiment and FIG. 8 (electrode arrangement B).

### (Function/Advantage)

The boundary between the electrodes and the midpoint position between adjacent positions at which the aspheric component of the reflection surface shape comprises extreme values coincide with each other, whereby it is possible to smoothly adjust the aspheric component.

[7] The variable shape mirror system according to claim 6, characterized in that

the drive unit controls the voltage in such a manner that potential differences applied to the respective electrodes of the plurality of pairs of electrodes hold predetermined linear relationships between the potential differences.

The variable shape mirror system according to [7] is based on the first embodiment, FIG. 10, and FIG. 11.

### (Function/Advantage)

The voltages of the second divided electrode, and third divided electrode are obtained on the basis of the voltage of the first divided electrode in accordance with the linear relationship, whereby it is possible to obtain the necessary reflection surface shape.

[8] The variable shape mirror system according to claim 7, characterized in that

the drive unit comprises a computing unit configured to derive, from a voltage of one electrode of the plurality of pairs of electrodes, voltages of the other remaining electrodes.

The variable shape mirror system according to [8] is based on the first embodiment and FIG. 1.

### (Function/Advantage)

The drive voltages of the electrodes obtained by the computing unit become the voltages configured to realize the optimum aspheric component in accordance with the curvature of the reflection surface, and hence it is possible to obtain the optimum aspheric component in accordance with the specified deformation amount.

[9] The variable shape mirror system according to claim 7, characterized in that

the drive unit comprises a nonlinear correcting unit for each electrode of the plurality of pairs of electrodes, and each correcting unit comprises a parameter.

The variable shape mirror system according to [9] is based on the second embodiment and FIG. 14.

### (Function/Advantage)

It is possible to obtain a deformation amount corresponding to the input target deformation amount signal, and an aspheric component corresponding to the deformation amount, in addition to the advantage of the first embodiment.

[10] The variable shape mirror system according to claim 8, characterized in that

the computing unit is configured to carry out linear operation.

The computing unit obtains a linear relationship on the basis of pairs of drive voltages for a plurality of obtained deformation amounts of the center of the reflection surface. The drive voltages of the electrodes obtained by the computing unit by utilizing the linear relationship become the voltages configured to realize the optimum aspheric component in accordance with the curvature of the reflection surface, and hence it is possible to obtain the optimum aspheric component in accordance with the specified deformation amount. It is not necessary to update the template during the control. This embodiment makes it possible to manufacture a variable shape mirror of a desired shape by simple control.

[11] The variable shape mirror system according to claim 8, characterized in that

the computing unit carries out conversion by using a table.

The variable shape mirror system according to [11] is based on the first embodiment and FIG. 1.

### (Function/Advantage)

The computing unit comprises a table in which relationships between the drive voltage values of the first divided electrode 3a, second divided electrode 3b, and third divided electrode 3c are stored, and can enhance the speed of the drive voltage acquisition processing.

[12] The variable shape mirror system according to claims 7 to 11, characterized in that

the computing unit outputs 0 V when a result of an operation becomes lower than 0 V.

The variable shape mirror system according to [12] is based on the first embodiment and FIG. 12.

### (Function/Advantage)

When, as a result of an operation, the drive voltage has a negative value, it is possible to bring the shape closer to the necessary reflection surface shape than the case where the negative voltage is applied by rounding off the operation result to 0 V.

[13] The variable shape mirror system according to claim 8, characterized in that

the drive unit is provided with a deformation amount sensor, and determines a voltage of one electrode of the plurality of pairs of electrodes in such a manner that a target deformation amount signal and an output of the deformation amount sensor coincide with each other.

The variable shape mirror system according to [13] is based on the modification example of the first embodiment and FIG. 13.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A variable shape mirror system comprising:
a deformation section on which a reflection surface and first electrode are formed;
a fixing section on which a second electrode is formed, and which is configured to fix the deformation section; and
a drive unit configured to apply a potential difference to a part between the first and second electrodes in order to deform the deformation section, wherein
at least one of the first electrode and second electrode is formed into divided electrodes constituted of a plurality of pairs of electrodes, and
in the divided electrodes, a division boundary between the electrodes comprises a circular shape, and is a circle concentric with an axis passing through a central point of the deformation section, and intersecting the reflection surface at right angles to the surface.

2. The variable shape mirror system according to claim 1, wherein
the second electrode is constituted of a plurality of divided electrodes, and the first electrode is arranged in opposition to the second electrode.

3. The variable shape mirror system according to claim 2, wherein
the electrode is divided in such a manner that a width of each of the plurality of pairs of electrodes in the radial direction coincides with a position at which an aspheric component of the shape of the reflection surface comprises an extreme value.

4. The variable shape mirror system according to claim 3, wherein
the drive unit controls the voltage in such a manner that potential differences applied to the plurality of pairs of electrodes hold predetermined linear relationships between the potential differences.

5. The variable shape mirror system according to claim 1, wherein
the drive unit comprises a computing unit configured to derive, from a voltage of one of the plurality of pairs of electrodes, voltages of remaining electrodes.

6. The variable shape mirror system according to claim 1, wherein
the drive unit comprises a nonlinear correcting unit for each of a plurality of pairs of electrodes, and each correcting unit comprises a parameter.

7. The variable shape mirror system according to claim 5, wherein
the computing unit is provided with a linear computing unit and memory in which a parameter of the computing unit is stored.

8. The variable shape mirror system according to claim 5, wherein
the computing unit is provided with a memory in which a table of relationships between the voltage of one of the plurality of pairs of electrodes, and voltages of the other remaining electrodes is stored.

9. The variable shape mirror system according to claim 5, wherein
the computing unit outputs 0 V when a result of an operation becomes lower than 0 V.

10. The variable shape mirror system according to claim 5, wherein
the drive unit is provided with a deformation amount sensor, and determines a voltage of one of the plurality of divided electrodes in such a manner that a target deformation amount signal input to the drive unit and an output of the deformation amount sensor coincide with each other.

11. The variable shape mirror system according to claim 2, wherein
the electrode is divided in such a manner that a division boundary between the plurality of pairs of electrodes coincides with a midpoint position between positions of extreme values of the aspheric component of the reflection surface shape adjacent to each other.

12. The variable shape mirror system according to claim 11, wherein
the drive unit according to claim 11 controls the voltage in such a manner that potential differences applied to the plurality of pairs of electrodes hold predetermined linear relationships between the potential differences.

13. The variable shape mirror system according to claim 1, wherein the first electrode is constituted of divided electrodes, and the second electrode is arranged in opposition to each other.

14. The variable shape mirror system according to claim 13, wherein
the electrode is divided in such a manner that a central position of a width of each of the plurality of pairs of electrodes according to claim 13 in the radial direction coincides with a position at which an aspheric component of the shape of the reflection surface comprises an extreme value.

15. The variable shape mirror system according to claim 14, wherein
the drive unit controls the voltage in such a manner that potential differences applied to the plurality of pairs of electrodes hold predetermined linear relationships between the potential differences.

16. The variable shape mirror system according to claim 13, wherein
the electrode is divided in such a manner that a division boundary between the plurality of pairs of electrodes coincides with a midpoint position between positions of extreme values of the aspheric component of the reflection surface shape adjacent to each other.

17. The variable shape mirror system according to claim 16, wherein
the drive unit controls the voltage in such a manner that potential differences applied to the plurality of pairs of electrodes hold predetermined linear relationships between the potential differences.

18. The variable shape mirror system according to claim 1, wherein
both the first electrode and second electrode are constituted of divided electrodes, and these electrodes are arranged in opposition to each other.

19. The variable shape mirror system according to claim 18, wherein
the electrode is divided in such a manner that a central position of a width of each of the plurality of pairs of electrodes in the radial direction coincides with a position at which an aspheric component of the shape of the reflection surface comprises an extreme value.

20. The variable shape mirror system according to claim 19, wherein
the drive unit controls the voltage in such a manner that potential differences applied to the plurality of divided electrodes hold predetermined linear relationships between the potential differences.

21. The variable shape mirror system according to claim 18, wherein
the electrode is divided in such a manner that a division boundary between the plurality of pairs of electrodes coincides with a midpoint position between positions of extreme values of the aspheric component of the reflection surface shape adjacent to each other.

22. The variable shape mirror system according to claim 21, wherein
the drive unit controls the voltage in such a manner that potential differences applied to the plurality of pairs of electrodes hold predetermined linear relationships between the potential differences.
